(19) United States
(12) Patent Application Publication
(10) Pub. No.: US 2013/0325557 A1
(43) Pub. Date: Dec. 5, 2013

(54) METHOD AND SYSTEM TO MANAGE TRAVEL COSTS

(71) Applicant: Flextronics Sales & Marketing (A-P), Ltd., Ebene (MU)

(72) Inventors: Christopher P. Ricci, Saratoga, CA (US); Jenica Blechschmidt, San Francisco, CA (US); James Hoak, San Francisco, CA (US)

(21) Appl. No.: 13/908,561

(22) Filed: Jun. 3, 2013

Related U.S. Application Data
(60) Provisional application No. 61/655,235, filed on Jun. 4, 2012.

(51) Int. Cl. G06Q 30/02

(52) U.S. Cl. CPC G06Q 30/0206
USPC 705/7.35

(57) ABSTRACT

The present disclosure is directed to an enterprise business expense assistant operable to determine a cost savings associated with a business associate selecting a travel and/or enterprise expense option and provide a portion of the cost savings to the associate as a cash payment or other benefit.

### CROSS REFERENCE TO RELATED APPLICATION

The present application claims the benefits of U.S. Provisional Application Ser. No. 61/655,235, filed Jun. 4, 2012, entitled “METHOD AND SYSTEM TO MANAGE TRAVEL”, which is incorporated herein by this reference in its entirety.

### FIELD

The disclosure relates generally to managing business and personal expenses and particularly to managing business travel and entertainment expenses.

### BACKGROUND

An ongoing challenge for most business and governmental entities is managing national and international travel expenses. While per diem limitations have traditionally been employed, they generally fail to reflect timely the effects of inflation and deflation in travel and entertainment expenses.

The advent of the Internet has provided immense savings in personal travel and entertainment expenses and to a lesser extent business travel and entertainment expenses. Travel booking vehicles, such as TRAVELOCITY™, PRICELINE.COM™, BINGTRAVEL™, AIRFAREWATCHDOG™, WHICHBUDGET.COM™, YAPTA.COM™, HOTELS.COM™, TRIPADVISOR™, SABER™, BEDANDBREAKFAST.COM™, HOMEAWAY.COM™, HOMEEXCHANGE.COM™, JETSETTER.COM™, and KAYAK™, have gained in popularity. Subscription based services, such as FEECATION™, offers subscribers reimbursement for travel fees, such as airline baggage fees, hotel resort fees, car rental fees, parking fees, and the like. In exchange for charging a monthly fee for service, partial reimbursement is provided for qualified types of expenses.

There is a need for an Internet-capable system for managing travel and entertainment expenses.

### SUMMARY

These and other needs are addressed by the various aspects, embodiments, and/or configurations of the present disclosure. The present disclosure is generally directed to an expense assistant operable to determine a cost savings associated with a business associate selecting a travel and/or enterprise expense option and provide a portion of the cost savings to the associate as a cash payment or other benefit.

A method can include the steps of:

(a) receiving, by a microprocessor executable enterprise business expense assistant, one or more parameters defining an enterprise travel and/or entertainment expense;

(b) determining, by the microprocessor executable enterprise business expense assistant, a reference point for the enterprise travel and/or entertainment expense;

(c) determining, by the microprocessor executable enterprise business expense assistant, a cost associated with the enterprise travel and/or entertainment expense;

(d) comparing, by the microprocessor executable enterprise business expense assistant, the determined cost and reference point to yield a cost savings associated with the enterprise travel and/or entertainment expense; and

(e) providing at least part of the cost savings, either as a cash payment or other type of incentive related to the cost savings, to an enterprise associate.

A system can include a microprocessor executable enterprise business expense assistant operable to:

(a) receive one or more parameters defining an enterprise travel and/or entertainment expense;

(b) determine a reference point for the enterprise travel and/or entertainment expense;

(c) determine a cost associated with the enterprise travel and/or entertainment expense;

(d) compare the determined cost and reference point to yield a cost savings associated with the enterprise travel and/or entertainment expense; and

(e) provide at least part of the cost savings, either as a cash payment or other type of incentive related to the cost savings, to an enterprise associate.

A non-transient, tangible computer readable medium comprising microprocessor executable instructions that, when executed, perform the following operations:

(a) receive one or more parameters defining an enterprise travel and/or entertainment expense;

(b) determine a reference point for the enterprise travel and/or entertainment expense;

(c) determine a cost associated with the enterprise travel and/or entertainment expense;

(d) compare the determined cost and reference point to yield a cost savings associated with the enterprise travel and/or entertainment expense; and

(e) provide at least part of the cost savings, either as a cash payment or other type of incentive related to the cost savings, to an enterprise associate.

The enterprise associate can be one or more of an employee, consultant, contractor, officer, director, equity owner, and board member.

The one or more parameters can comprise one or more of date and/or time of departure, date and/or time of arrival, departure location, arrival location, meeting date and/or time, meeting location, type of the at least one of an enterprise travel and expense, reservation date and/or time, and whether the at least one of an enterprise travel and expense is round-trip or one-way.

The type of the enterprise travel and/or entertainment expense can be one or more of air travel fare, rental car rental, restaurant dining cost, hotel rate, motel rate, cruise ship fare, ferry charge, cab fare, railway passenger fare, and mass transit fare.

The cost associated with the enterprise travel and/or entertainment expense can be determined based on expense information provided by the Internet website of a service provider associated with the enterprise travel and/or entertainment expense, a navigation and/or mapping application, and a service providing information regarding service provider costs.

The expense information can be one or more of air passenger carrier, rail passenger carrier, transit, ship, and ferry destinations, schedules, and seat availabilities, travel times between a selected origin and destination, air, rail, transit, ship and ferry fares, rental car availability and rental rates, hotel and/or motel rates and availabilities, restaurant identities, locations, menu and/or food types or selections, and costs, airport, terminal, transit, bus, train, rental car vendor, and hotel/motel, and locations of a point of interest and other locations of interest.

The cost associated with the enterprise travel and/or entertainment expense can be determined by determining, based on the one or more parameters, a plurality of user options and, for each user option and based on the expense information, an associated cost.

The reference point is commonly a cost for the at least one of an enterprise travel and entertainment expense and can be determined by the one or more parameters and based on one or more of prior instances of the enterprise travel and/or entertainment expense, expense information for the enterprise travel and/or entertainment expense, a policy and/or rule of the enterprise, prior behavior of the enterprise associate, a hierarchical ranking of the enterprise associate within the enterprise, and a per diem allowance of the enterprise.

The cost associated with the enterprise travel and/or entertainment expense can be determined by filtering the plurality of user options based on one or more enterprise rule sets to provide a set of filtered options and thereafter providing the filtered options to the enterprise associate for selection of a preferred filtered option, the cost associated with the preferred filtered option being the cost associated with the enterprise travel and/or entertainment expense.

The present disclosure can provide a number of advantages depending on the particular aspect, embodiment, and/or configuration. The disclosure can provide a gain share model to business travel and entertainment expenses, thereby connecting cost-saving with cash payments to employees and creating an incentive for employees to select less expensive travel and entertainment options. By quantifying gains realized by the enterprise as a direct result of its efforts to save costs, enterprise employees can influence directly his or her paychecks. The disclosure can provide these benefits as a third party vendor to enterprises whereby the vendor and employee both take a share of the savings realized by more optimal selection of travel and entertainment options. This can be done without subscription, booking, fees or other transaction costs either to service providers or the enterprise. The user can have greater satisfaction due to a financial benefit from selecting a less expensive travel or entertainment option and feel less frustrated with making travel arrangements. In addition to experiencing significant travel and entertainment cost savings, the enterprise can also align employee goals with those of the enterprise, receive data tracking and analysis of travel and entertainment expenses for refining rule sets 220, have greater visibility into the travel and entertainment budget and expenses, and have greater negotiation power vis a vis service providers. Service providers can have no booking fees compared to other travel sites, have greater occupancy levels, increased loyalty with consumers, and higher seat occupancy levels.

These and other advantages will be apparent from the disclosure.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

“A” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

“Computer-readable medium” as used herein refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “database” as used herein refers to an organized set of data held in a computer. The organization schema or model for the data can, for example, be hierarchical, network, relational, entity-relationship, object, document, XML, entity-attribute-value model, star schema, object-relational, associative, multidimensional, multivalue, semantic, and other database designs.

“Determine”, “calculate” and “compute,” and variations thereof, as used herein, are used interchangeably and include any type of methodology, process, mathematical operation or technique.

An “enterprise” refers to a business and/or governmental organization, such as a corporation, partnership, joint venture, agency, military branch, and the like.

“Instant message” and “instant messaging” refer to a form of real-time text communication between two or more people, typically based on typed text.

“Internet search engine” refers to a web search engine designed to search for information on the World Wide Web and FTP servers. The search results are generally presented in a list of results often referred to as SERPS, or “search engine results pages”. The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as Alta Vista™, store every word of every page they find.

“Means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

“Module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

“Online community”, “e-community”, or “virtual community” mean a group of people that primarily interact via a computer network, rather than face to face, for social, professional, educational or other purposes. The interaction can use a variety of media formats, including wikis, blogs, chat rooms, Internet forums, instant messaging, email, and other forms of electronic media. Many media formats are used in social software separately or in combination, including text-based chatrooms and forums that use voice, video text or avatars.

“Social network service” is a service provider that builds online communities of people, who share interests and/or activities, or who are interested in exploring the interests and activities of others. Most social network services are web-based and provide a variety of ways for users to interact, such as e-mail and instant messaging services.

“Social network” refers to a web-based social network.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram depicting an exemplary architecture according to an embodiment;

FIG. 2 is a block diagram depicting an exemplary architecture according to an embodiment;

FIG. 3 is a flow chart of exemplary logic according to an embodiment;

FIG. 4 is a flow chart of exemplary logic according to an embodiment;

FIG. 5 is a flow chart of exemplary logic according to an embodiment;

FIG. 6 is a screenshot of a display according to embodiment;

FIG. 7 is a flow chart of exemplary logic according to an embodiment;

FIG. 8 is a flow chart of exemplary logic according to an embodiment;

FIG. 9 is a flow chart of exemplary logic according to an embodiment; and

FIG. 10 is a flow chart of exemplary logic according to an embodiment.

### DETAILED DESCRIPTION

The Network-Based Architecture

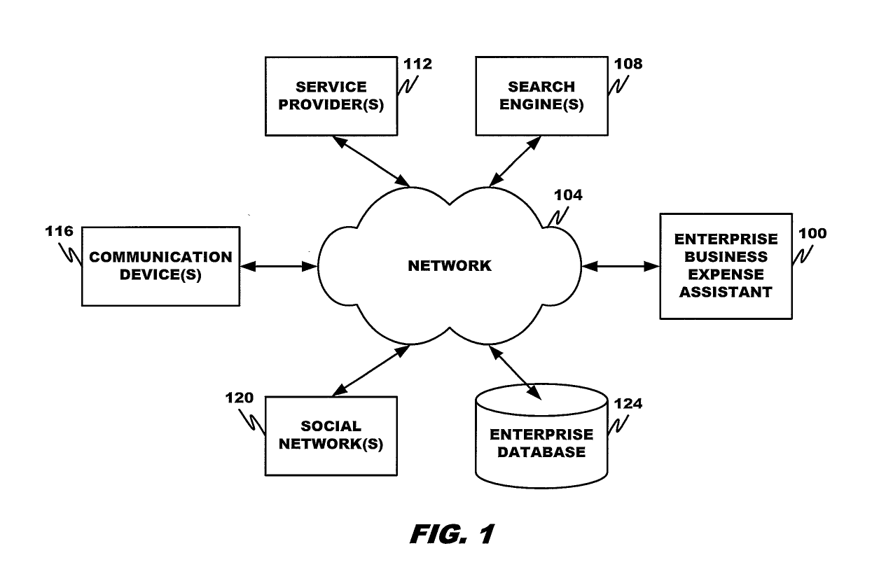

FIG. 1 depicts an exemplary network-based architecture according to an embodiment. The architecture includes an enterprise business expense assistant 100 interconnected, via network 104, with one or more search engines 108, one or more service providers 112, one or more subscriber or nonsubscriber communication device(s) 116, one or more social networks 120, and an enterprise database 124.

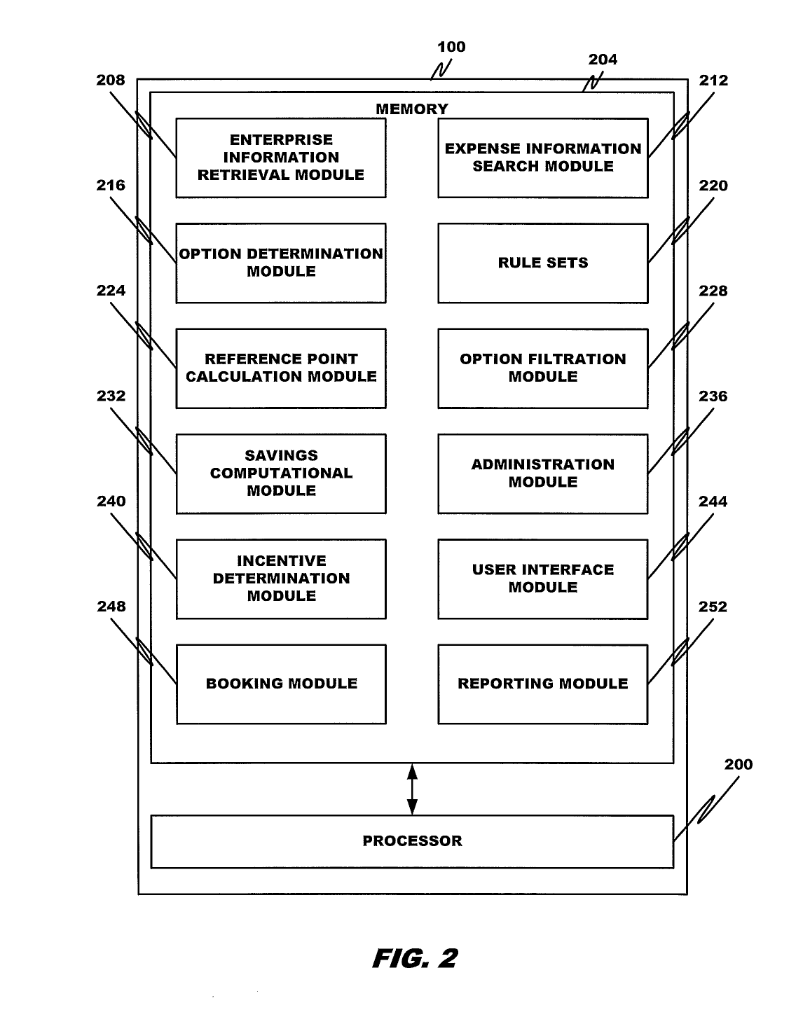

The enterprise business expense assistant 100, as discussed more fully in connection with FIG. 2 below, can apply a “gain share” model for business (and personal) travel and entertainment expenses and provide an incentive system connecting cost-savings with a user benefit, such as a cash payment. “Gain sharing”, which typically is a close cousin of profit-sharing, can empower those who are removed from decisions affecting enterprise profits. By way of illustration, the assistant 100 can take, as an input, the rates and schedules that define or determine a service provider, such as an airline, car rental company, railway company, hotel, motel, and the like, determine options for the user, each option having a different associated cost savings (to the enterprise) and/or user benefit if selected, and, based upon the selected option, provide the user with a benefit commensurate with, related to, or proportional to the option.

The network(s) 104 can be any wired or wireless, public or private, trusted or untrusted distributed processing network, including, for example, a local area network, wide area network (such as the World Wide Web), and/or a regional network, or combinations thereof. A common network(s) 104 uses the Transport Control Protocol (“TCP”) and/or Internet Protocol (“IP”).

The search engine(s) 108 can be any suitable search engine, particularly an Internet search engine, that obtains determined types of information from the service provider websites 112, social networks 120, and/or an enterprise database 124 associated with the enterprise in turn associated with the enterprise business assistant 100.

The service provider(s) can any entity providing information regarding or services relating to travel and/or entertainment. Examples include major, regional, and charter airlines, rental car companies, restaurants, hotels, motels, cruise ship operators, ferry operators, cab operators, railway operators, booking or travel agencies, mass transit operators, travel and/or entertainment expense information providers, and the like. Examples include AMERICAN AIRLINES™, UNITED AIRLINES™, SOUTHWEST AIRLINES™, NORTHWEST AIRLINES™, KLM AIRLINES™, AIR FRANCE™, BRITISH AIRWAYS™, LUFTHANSA™, JAPAN AIRLINES™, ACE RENT A CAR™, ADVANTAGE RENT A CAR™, ALAMO RENT A CAR™, AUTO EUROPE™, AVIS RENT A CAR™, DOLLAR RENT A CAR™, ECONOMY CAR RENTAL™, REDSPOT CAR RENTALS™, SIXT™, THRIFTY CAR RENTAL™, FOUR SEASONS HOTEL AND RESORTS™, JW MARRIOTT HOTELS™, STARWOOD-WESTIN HOTELS™, HILTON™, MARRIOTT™, HYATT™, CONRAD HOTELS™, INTERCONTINENTAL HOTELS™, RITZ-CARLTON™, DORCHESTER COLLECTION™, HOLIDAY INN™, COURTYARD BY MARRIOTT™, HILTON GARDON INN™, HAMPTON INN™, HOLIDAY INN EXPRESS™, FAIRFIELD INN™, FOUR POINTS BY SHERATON™, RESIDENCE INN BY MARRIOTT™, HILTON GRAND VACATIONS™, WESTGATE RESORTS™, MOTEL 6™, ROYAL CARRIBEAN INTERNATIONAL™, PRINCESS CRUISES™, CARNIVAL CORPORATION™, YELLOW CAB COMPANY™, SUPERSHUTTLE™, TRAVELOCITY™, PRICELINE.COM™, MAPQUEST™, BINGTRAVEL™, AIRFAREWATCHDOG™, WHICHBUDGET.COM™, YAPTA.COM™, HOTELS.COM™, TRIPADVISOR™, SABER™, BEDANDBREAKFAST.COM™, HOMEAWAY.COM™, HOMEEXCHANGE.COM™, JETSETTER.COM™, and KAYAK™.

The subscriber and/or nonsubscriber communication devices 116 can be associated with an employee, contractor, or other enterprise associated or affiliated user and can be any network (e.g., Internet) capable communication device, such as a personal computer, laptop, notebook computer, tablet computer, cellular phone, personal digital assistant, or other computerized device.

The social networks 120 can be any social network, such as one maintained by a social network service, or other online community. Exemplary social networks include Linkedin™, Twitter™, Second Life™, YouTube™, DailyMotion™, Facebook™, Foursquare™, and Facebook Places™

The Enterprise Business Expense Assistant 100

With reference to FIG. 2, the enterprise business expense assistant 100 comprises a microprocessor 200 and associated computer readable medium 204 that includes a number of computational modules. The modules include an enterprise information retrieval module 208, an expense information search module 212, an option determination module 216, one or more rule sets 220, a reference point calculation module 224, an option filtration module 228, a savings computational and reporting module 232, an administration module 236, an incentive determination module 240, a user interface module 244, a booking module 248, and a reporting module 252.

The enterprise information retrieval module 208 collects, from the enterprise database 124, enterprise information. Enterprise information includes any information related to the enterprise, its policies and/or operations, and/or personnel. Exemplary enterprise information includes employee and/or consultant identification, contact, location of employment, residential address, job descriptions and/or positions, business hierarchy (e.g., relative importance of each position to managing the enterprise such as vice president, chief executive officer, board member, director, clerical staff, and the like), rule sets 220, electronic calendars such as Microsoft Outlook™, client and/or business contact identities and locations, and other business, financial, and personnel information (such as would be maintained in a personnel database like WORKDAY™). In some applications, the enterprise retrieval module 208 can supplement enterprise information by obtaining relevant user information from one or more social networks 120. Supplemental information includes, for example, information regarding the user's entertainment and travel likes, dislikes, and preferences, which may not be available in the enterprise database 124.

The expense information search module 212, using search engine(s) 108, obtains expense information from service provider(s) 112, services providing information about service providers and/or services thereof, and other information sources. Examples of expense information include air passenger carrier, rail passenger carrier, transit, ship, and ferry destinations, schedules, and seat availabilities, travel times between a selected origin and destination (such as would be provided by MAPQUEST™ or other navigation and/or mapping software), air, rail, transit, ship and ferry fares, rental car availability and rental rates, hotel and/or motel rates and availabilities, restaurant identities, locations, menu and/or food types or selections, and costs, airport, terminal, transit, bus, train, rental car vendor, and hotel/motel, locations of a point of interest and other locations of interest, and other information related to travel and/or entertainment costs and expenses. In one configuration, the expense information search module 212 uses one or more Internet search engines to obtain, such as by scraping or other searching techniques, information from websites of the service providers. For example, the expense information search module 212 can use an application program interface to interface with available travel programs, scrape or otherwise search websites, and/or the raw data from a service provider. The search engine(s) 108 can alternatively and/or additionally search private databases, such as Saber™ and other subscription-based and freely searchable databases.

The option determination module 216 determines, using user inputted expense parameters, optionally using one or more applicable rule sets 220, and pertinent expense information, travel and/or entertainment options for the user and the gross cost of each option. For example, the option determination module 216 would provide multiple restaurant selections each having an associated cost for a typical or user selected meal, multiple passenger carrier (e.g., air, train, bus, ship, or combination thereof) options each having an associated airfare and trip duration, multiple rental car options each having an associated rental rate and other terms, multiple hotel and/or motel options each having an associated daily room rate, and the like. The option determination module 216 can use, as an input, the rates and schedules that define flights, car rentals, train routes, hotels, motels, and the other expense information.

The rule set(s) 220 are user, administrator, and/or default configured and define what options are permissible and/or desirable for the enterprise. By way of illustration, an enterprise officer may be entitled to fly on first, business, economy plus, or economy class on any flight while a lower level enterprise employee may be entitled to fly only on economy plus or economy class on any flight, an enterprise officer may be entitled to fly on first, business, economy plus, or economy class on any flight lasting longer than 5 hours while a lower level enterprise employee may be entitled to fly only on business, economy plus, or economy class on any such flight, all enterprise employees must rent a standard size, compact or subcompact car, director level enterprise employees and below may stay in three, two, or one-star hotels and/or motels, enterprise employees may select only a flight, hotel, motel, rental car, and the like with a price of X % greater than the lowest price provided, enterprise employees must always select non-refundable fares, when an enterprise arranges a reduced corporate fare with a hotel or motel chain, preference is given to that chain when a hotel or motel is located within a predetermined distance from the destination, an acceptable flight must have no more than 2 layovers for continental or domestic travel, no layovers are permitted for enterprise officers, and the like. As will be appreciated, innumerable rule sets may be employed depending on the specific requirements of the application.

The reference point calculation module 224 is a maximum, target, average, median, benchmark, or policy or rule-determined cost for the enterprise travel and/or entertainment expense and determines the reference point from which a user incentive or benefit is determined. The algorithm used to determine the reference point can be as simple or complex as desired. For instance, the reference point can be determined by the expense parameters inputted by the user and based on one or more of prior or historic (similar) instances of the enterprise travel and/or entertainment expense for the same or different users, expense information for the travel and/or entertainment expense, a policy and/or rule of the enterprise, prior behavior of the user, a hierarchical ranking of the user within the enterprise, and a per diem allowance of the enterprise. Different enterprise associates, whether at the same or different hierarchical levels in the enterprise, can have the same or different reference points for the same enterprise travel and/or entertainment expense.

A reference point can be a simple calculation of the cost of the trip (e.g., the total cost of the roundtrip flight to Newark from San Jose and from Newark to San Jose, hotel for the night before the meeting, parking at the airport, and a car (either rented or a cab) to the meeting from the hotel and from the meeting to the airport for the return flight) or simply the cost of each trip component (e.g., the cost of each of (a) the roundtrip flight to Newark from San Jose and from Newark to San Jose, (b) hotel for the night before the meeting, (c) parking at the airport, and (d) a car (either rented or a cab) to the meeting from the hotel and from the meeting to the airport for the return flight). In the former case, the option cost is determined for the entire trip and, in the latter case, for each of the (a), (b), (c), and (d) trip components.

The reference point calculation can be more complicated. If the user were to book the trip at least three weeks before the trip, the flight would be substantially less expensive. However, it may be beyond the enterprise associate's control to do so. Thus, it is a setting within an administrative panel to determine how much emphasis the enterprise will put on possible savings as opposed to known savings. When the enterprise chooses to emphasize this type of savings, it can set a percentage. The reference point for 100% emphasis means that the lowest prices for the trip within the prior month (also settable by administration) would be the reference point. A 50% emphasis takes the difference between the current acceptable value of the trip under the enterprise rules and the lowest price of the trip in the prior month. That amount represents the potential savings had the enterprise associate planned better. Then one-half of that amount represents the penalty to the enterprise associate for poor planning. Thus, when the potential savings is calculated, the reference point against which the savings are determined is the average of the acceptable trips under the rules, less the penalty.

Other options for the reference point calculation include dynamic reference points, which use the enterprise's data on an individual traveler (e.g., how much does a particular user X normally pay for flights to Chicago) and current travel conditions (e.g., what is the current market price for a 3.5 star hotel in Chicago), with expensive users traveling premium flights and staying in premium hotels, medium priced users traveling mid-price flights and staying in mid-priced hotels, and the lesser priced users traveling cheap flights and staying in cheap hotels or with friends/family. In the example, expensive users would have a higher reference rate or point than lesser priced users. To create additional savings, the enterprise would want an expensive user to move into a medium travel profile and a lesser priced user to remain where he or she is. Meanwhile, at the end of a quarter of the enterprise calendar or fiscal year, a user is rewarded for being consistently a lesser priced user, thereby overcoming differences in payouts for different enterprise associates who may be in the same office.

As data is collected, the assistant 100 can be specifically set to target different groups or tiers of enterprise associates or specific enterprise associates. Under this option, lesser priced users will receive a higher percentage split when compared to medium and premium priced users, and medium priced users will receive a higher percentage split when compared to premium priced users. In another approach, users who have a higher frequency of travel (such as sales or service people) will receive a higher percentage split when compared to those associates who have a lower frequency of travel. This will incentivize spenders to select less expensive options and thereby providing greater savings to the enterprise.

Other options for the reference point calculation include simplified reference points, which use the enterprise's corporate travel rules and current market prices. In this structure, the percentage distribution may be variable. For example, at lower savings levels, such as less than one hundred dollars, the enterprise may wish to provide a greater incentive to associates. For example, the associate incentive (e.g., cash back) participation may increase from the aforementioned 25% to 50% to try to increase travel cost savings participation.

Yet another option for the reference point calculation uses a rule set 220, such as an associate must select among the lowest priced three non-stop flights, stay in a three-star hotel, must fly internationally by a one-way business class ticket, etc.) and current market prices (in each geographic location visited by the user during the trip) in determining the reference point. For example, the reference point could be the highest expense associated with a permissible option under the selected rule set 220.

Yet other options for the reference point calculation can use a per diem allowance for the reference point. The per diem allowance typically varies by geographical area and would be applied to geographically collocated components of the trip. For example, Denver would have a lower per diem rate than New York. The per diem for Denver would be applied to the user when in Denver, and the per diem for New York applied to the user when in New York.

Yet other options for the reference point calculation are combinations of the prior to reference point types. For example, the assistant 100 can start with the second or prior option while gaining data about individual users. Once a user profile is determined by the system, the reference point calculation module 224 migrates to the first option.

The option filtration module 228 applies rule sets 220 to filter out from the options determined by the option determination module 216 the undesirable options for the enterprise and/or to flag the more desirable options and thereby distinguish them from less desirable options. The more desirable options could then be flagged or otherwise emphasized when presented the user and/or greater cash-back percentages applied to more desirable options.

For example, the filtration module 228 can filter the options based upon the rule sets 220 and offer both itineraries that are available under the rules and alternative itineraries that result in a cost savings to the enterprise. By way of illustration, if a meeting were in Manhattan and the travel were coming from Boston, an early morning train, leaving at 5 am, may get the traveler to Penn station in time to catch a cab and make it to the meeting. The person may also be entitled to fly in the previous evening and stay at a hotel under the rule sets 220. The train may result in a $300 cost savings to the company.

The savings and reporting computational module 232 determines for each filtered option the savings for the enterprise, which is related to the cash-back incentive to be paid to the user. The savings can be based on the trip as a whole (using a reference point for the entire trip) and/or for each cost component of the trip (using separate reference points for each trip component). An example of the former is to determine a cost for the entire trip (e.g., the total cost of the roundtrip flight to Newark from San Jose and from Newark to San Jose, hotel for the night before the meeting, parking at the airport, and a car (either rented or a cab) to the meeting from the hotel and from the meeting to the airport for the return flight) and using a reference point for the entire roundtrip from San Jose to Newark. An example of the latter is to determine the cost of each trip component (e.g., the cost of each of (a) the roundtrip flight to Newark from San Jose and from Newark to San Jose, (b) hotel for the night before the meeting, (c) parking at the airport, and (d) a car (either rented or a cab) to the meeting from the hotel and from the meeting to the airport for the return flight) and using a reference point for each of (a), (b), (c), and (d). The individual savings from each of the components (a), (b), (c), and (d) is summed for the total savings figure.

The administration module 236 provides a user interface and enforces security privileges to enable administrators to change securely parameters for the assistant 100. In the absence of tight security enforcement, associates could alter the system settings and parameters to provide he or she with greater incentives for lesser cost savings for the enterprise.

In more sophisticated applications, the administration module 236 can determine from entries on a user's electronic calendar and invites sent to other enterprise associates when a user schedules a trip. This can be beneficially used to prompt an enterprise associate well in advance of the need to book travel arrangements to realize early booking savings. Additionally, the administration module 236 can determine from multiple associate's electronic calendars and/or invites when multiple users are scheduled to be on the same trip. The administration module 236 can prompt each of the associates to book travel arrangements concurrently or together to realize savings through group rates.

In other applications, when the administration module 236, based on electronic calendar information and/or assistant 100 user behavior, recognizes travel by a single or multiple associates with the same city pairs and/or dates, the administration module 236 can recommend to an administrator to purchase a block of tickets. For instance, if it is discovered that the enterprise is purchasing tickets between San Francisco and Hong Kong an average of once per month, the administration module 236 can recommend to an administrator that the enterprise buy a block of twelve tickets from an airline for that city pair, thereby driving savings. Due to the use of this ancillary data resulting in additional savings to the enterprise, the enterprise can afford to increase the percentage cash payback to the associate.

Similarly, the assistant 100-collected data regarding the behavior of users can be used by service provider, such as airline, to affect specified behavior. For example, if the assistant 100 were to identify that the enterprise regularly sends a large number of people to a certain destination, it could use that knowledge to provide special offers to the enterprise to purchase tickets on unfilled flights to travel to that destination to incentivize enterprise behavior and fill the empty seats on the flights.

The incentive determination module 240 determines, for the user and selected option, the eligible cost savings for the enterprise and therefore the magnitude of the incentive (or amount of monetary payment) to the user. While the offered “incentive” is discussed with reference to a monetary payment, it is to be understood that the incentive can take innumerable other forms, such as vacation time, a gift card, free or subsidized purchase of a product and/or service (e.g., if the enterprise associate earns X points, he or she gets a free television or a television at a greatly discounted price), use of a company resource (such as a vehicle or lodging facility), formal recognition by senior management and/or other employees, and the like. This computation requires the module 240 to determine not only the enterprise cost savings for the option selected but also the eligible incentive bonus rate to be applied to the savings to provide the monetary or cash-back payment to the user.

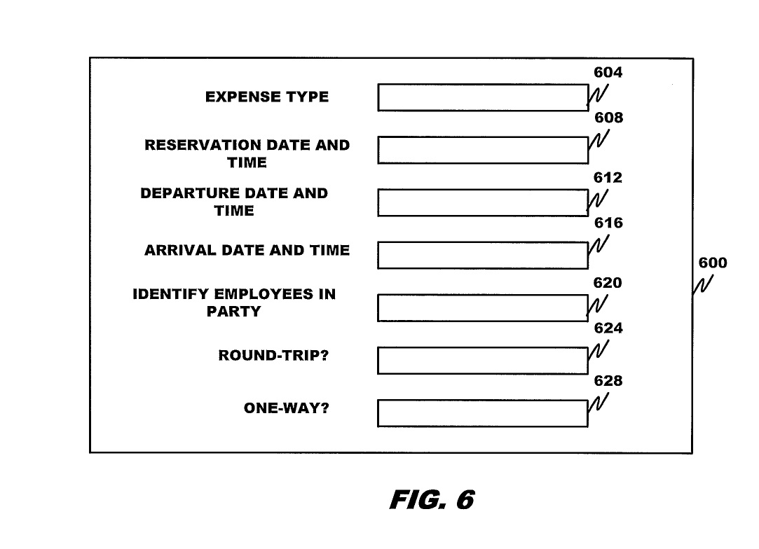

The user interface module 244 provides displays to the user to obtain the expense parameters for the travel or entertainment expense. An example of a display is shown in FIG. 6. The display 600 includes plural fields to be completed by the user. The fields include expense type 604 (e.g., hotel only, flight only, car only, cruise only, restaurant, other, and any combination of the foregoing (e.g., flight+hotel, hotel+car, flight+hotel+car, etc.)), reservation date and time 608 (e.g., for restaurants), departure date and time 612, arrival date and time 616, identification of enterprise associates in party 620, round trip? 624 (if selected, meaning that the trip itinerary is a round trip), and one-way? 628 (if selected, meaning that the trip itinerary is a one-way trip).

In other applications, the user sees a standard search system for planning a trip. The local airport is defaulted to the local airport (or originating airport). The user puts in, not the preferred airport, but the location of the meeting or meetings. By doing so, the assistant 100 can determine which airports to search. The administrator will have loaded among the rule sets 220 how far an airport can be before it is too far to travel. For example, flying into an airport that is three hours from the meeting place is not an acceptable choice. This same function can work for hotels and motels. A distance from a meeting of one mile may be a reasonable outer limit if the meeting is in a major city. However, if the meeting were to be in a rural setting, then ten miles may be a reasonable location.

The user can also input the time of the meeting. Again, the assistant 100 makes a reasonable estimate of travel times from locations, including traffic, such as by using a navigation and mapping program. For instance, an arrival of 8 am in Newark for a meeting at 9 am in Manhattan is unreasonable so the assistant 100 can filter these results and possibly offer flights coming in the previous evening. From a cost perspective, the additional hotel stay is also factored in.

The booking module 248 receives the selected options and books and generates the itinerary and/or entertainment activity.

The reporting module 252 generates a number of report types. For example, the reporting module 252 can provide a trip report, including expenses for easy inclusion into an expense report program. This could also be linked directly to an expense program, such as the one offered by CONCUR™. Another report is the cost analysis tool. This report can assist the user and/or administrator in determining, for example, how much time does the user have to book before prices change materially and/or how much could have been saved had the trip been booked earlier. In yet another reporting function, the reporting module 252 provides a periodic reminder, such as by instant message or email, to the user with a report on how much he or she could have made versus how much he or she actually made through the incentive.

The Operation of the Enterprise Business Expense Assistant

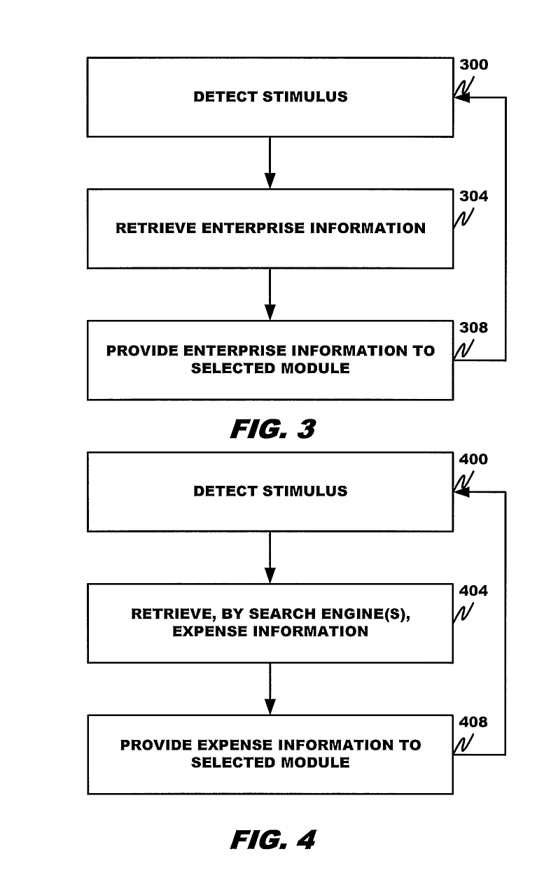

Referring to FIG. 3, the operation of the enterprise information retrieval module 208 is depicted.

In step 300, the module 208 detects a stimulus, such as a user query, a query from another module of the assistant 100, an interrupt such as generated in response to a clock setting, and the like.

In step 304, the module 208, in response, retrieves determined enterprise information. The enterprise information to be retrieved can be based on user identity, query, and the like.

In step 308, the module 208 provides the enterprise information to a selected module of the assistant 100.

The module then returns to step 300 to await the next stimulus instance.

Referring to FIG. 4, the operation of the expense information search module 212 is depicted.

In step 400, the module 212 detects a stimulus, such as a user query, a query from another module of the assistant 100, an interrupt such as generated in response to a clock setting, and the like.

In step 404, the module 212, in response, retrieves, by one or more search engines, determined expense information. The expense information to be retrieved can be based on user identity, query, administrator settings, and the like.

In step 408, the module 212 provides the expense information to a selected module of the assistant 100.

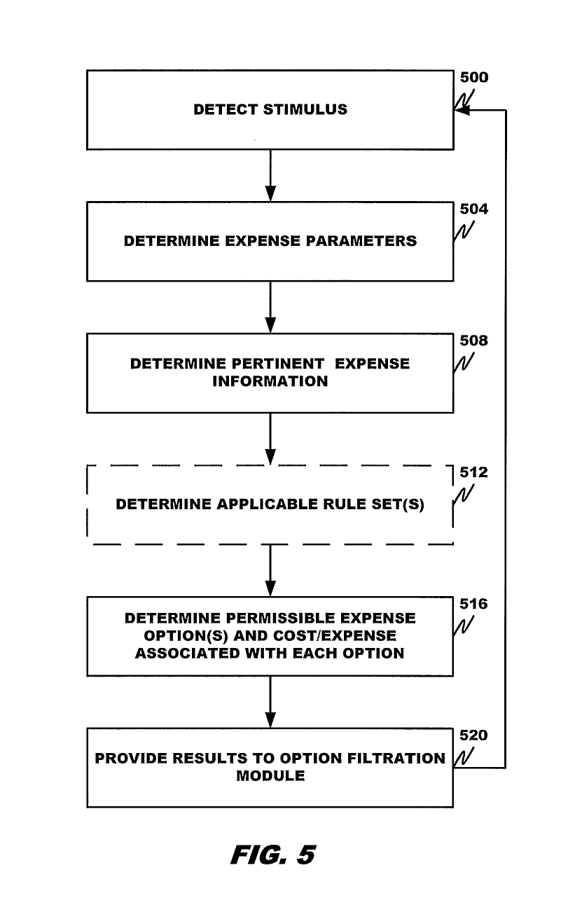

Referring to FIG. 5, the operation of the option determination module 216 will be described.

In step 500, the module 216 detects a stimulus, such as a user query, a query from another module of the assistant 100, and the like.

In step 504, the module 216 determines expense parameters, such as input by the user through the user interface module 244.

In step 508, the module 216 determines pertinent expense information, which is usually related to a user query and/or the expense parameters.

In step 512, the module 216 optionally determines one or more applicable rule sets.

In step 516, the module 216 determines permissible expense option(s) and a cost/expense associated with each option. This is typically done for each trip component and summed for the option to provide the total cost/expense.

In step 520, the module 216 provides results to the option filtration module 228.

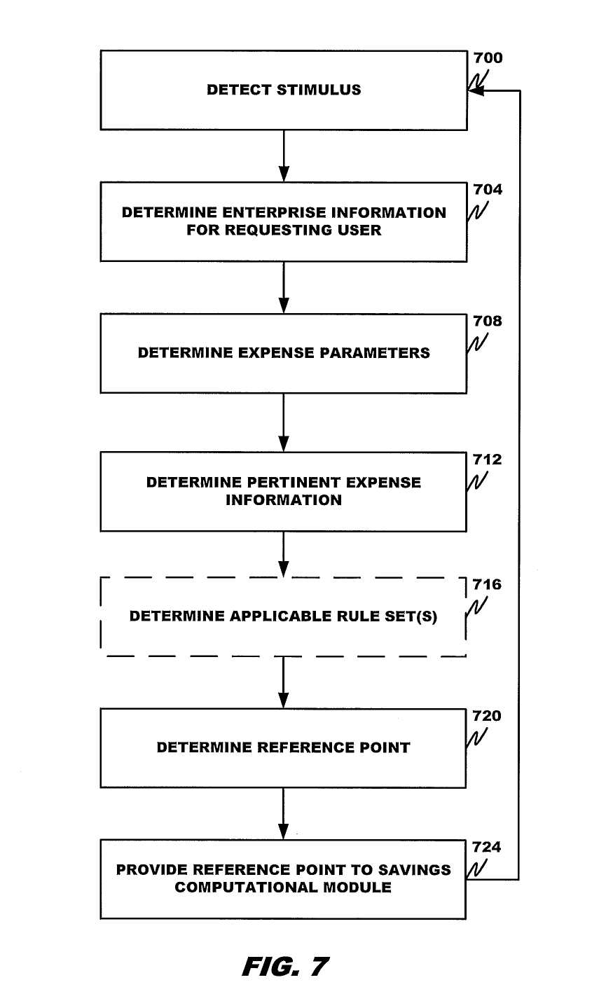

Referring to FIG. 7, the operation of the reference point calculation module 224 will be discussed.

In step 700, the reference point calculation module 224 detects a stimulus, such as a user query, a query from another module of the assistant 100, and the like.

In step 704, the reference point calculation module 224 determines enterprise information for the requesting user.

In step 708, the reference point calculation module 224 determines expense parameters defining the proposed travel activity.

In step 712, the reference point calculation module 224 determines pertinent expense information for the proposed travel activity.

In optional step 716, the reference point calculation module 224 determines applicable rule sets 220, if any relevant to the reference point calculation.

In step 720, the reference point calculation module 224 determines the reference point.

In step 724, the reference point calculation module 224 provides the reference point to the savings computational module.

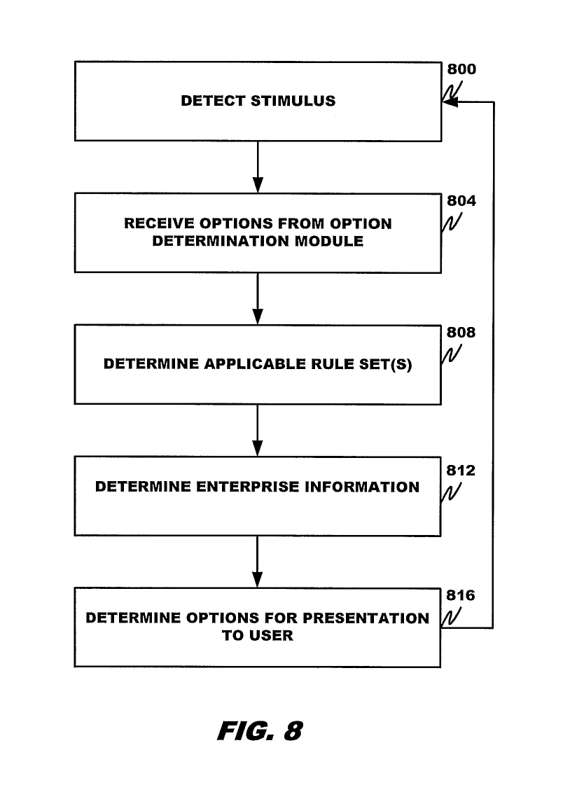

Referring to FIG. 8, the operation of the option filtration module 228 is depicted.

In step 800, the module 228 detects a stimulus, such as notification of options from the option determination module 216.

In step 804, the option filtration module 228 receives the options from the option determination module 228.

In step 808, the option filtration module 228 determines applicable rule sets 220.

In step 812, the option filtration module 228 determines applicable enterprise information required to apply rule sets 220.

In step 816, the option filtration module 228 determines options for presentation to the user.

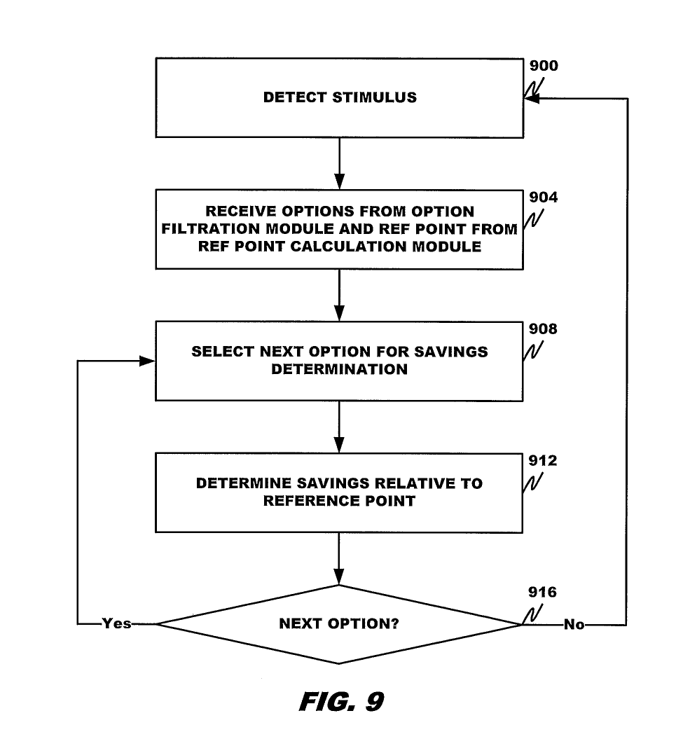

Referring to FIG. 9, the operation of the savings computational module 232 is depicted.

In step 900, the module 232 detects a stimulus, such as notification of options from the option filtration module 228.

In step 904, the module 232 receives (filtered) options from the option filtration module 228 and the reference point from the reference point calculation module 224.

In step 908, the module 232 selects a next (filtered) option for savings determination.

In step 912, the module 232 determines savings relative to the reference point.

In decision diamond 916, the module 232 determines if there is a next option. If not, the module 232 proceeds to step 900. If so, the module 232 returns to step 908.

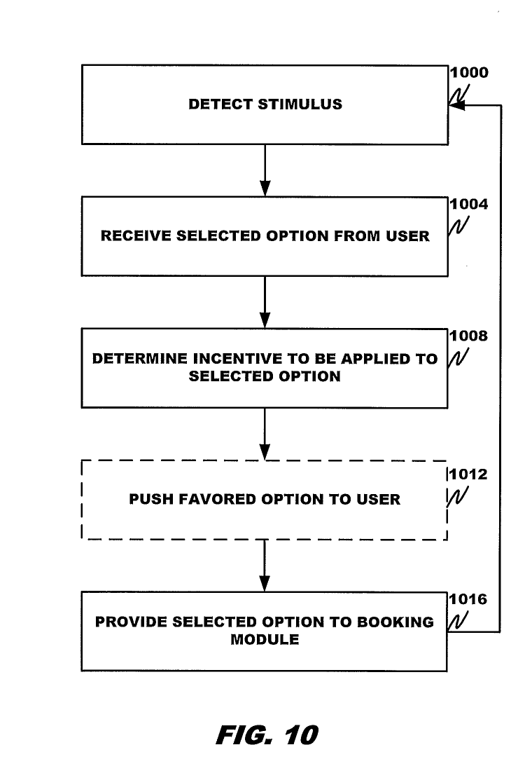

Referring to FIG. 10, the operation of the incentive determination module 240 is depicted.

In step 1000, the module 240 detects a stimulus, such as a notification from the savings computational module 232.

In step 1004, the module 240 provides the various options, associated cost, and incentive to the associate and receives the selected option from the user. Users are not commonly notified of the reference point used in savings determination or how much the enterprise is saving; the emphasis is on how much the user is getting paid.

In step 1008, the module 240 determines the incentive to be applied to the selected option.

In optional step 1012, the module 240 pushes or emphasizes the favored option to the user. This can be done for example, by the order in which the options are presented to the user and/or altering the presentation format of the options to make the preferred options more attractive to the user than the less preferred options. In another example, when an associate has options that would save the enterprise more money than the selected option, he or she is again informed at checkout of the availability of that option. For instance, associates can be notified unobtrusively that he or she could be paid $[X] if they were to select a one-stop flight that left [Y] hours earlier or later or a [Z star] hotel within [N] miles of his or her current selection. If he or she were to choose to take the more expensive option, possibly limited to a predetermined percentage from the reference point, he or she may be asked why with the response and other data surrounding the selection being provided to a supervisor for approval.

In step 1016, the module 240 provides the selected option to the booking module and records the incentive entitled to be received by the user.

An example of the assistant 100 in operation will now be discussed.

Assume that the user desires to travel from Newark to attend a 9 am meeting in Manhattan. The assistant 100 determines that an early morning train, leaving at 5 am, may get the traveler to Penn station in time to catch a cab and make it to the meeting. The person may also be entitled to fly in the previous evening and stay at a hotel. The train may result in a $300 cost savings to the company relative to an average entitled travel option (or reference point).

If the user were to select the lower cost alternative to the average entitled travel option, the cost savings is calculated as $300. In a more complicated example, the assistant 100 would extend the savings to include the fact that parking at the train station is free and a car rental or limousine would be needed if the user were to fly to Newark, as compared to a simple cab ride. Thus, the savings can be extended.

Once the savings is computed, a set percentage of the savings is offered to the user as an incentive to take the less-preferred travel option. In the example, the enterprise can offer the user 25% of the savings (a percentage set by the administrator in the rules interface) to take the train. This would result in the user receiving $75 to take the train. The enterprise then gets a savings based upon the difference.

In terms of the user interface, by mousing (e.g., passing the mouse cursor) over a particular travel option, the user is notified of the amount of money he or she will be paid by choosing a particular train, flight, hotel, car, etc. Once the user selects an option, a preview comes up describing his or her payment for taking the train.

To determine the savings, the price of the travel option is compared to a reference point and a percentage of the difference between the travel option price and the reference point is distributed to the associate in his or her next paycheck. Again, this can be achieved through a reporting feature or directly through a personnel database.

The associate is not notified of the reference point or how much the enterprise is saving. The focus is on how much he or she is getting paid.

The exemplary systems and methods of this disclosure have been described in relation to a distributed architecture. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a communication device, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, the various modules of the assistant 100 can be collocated on a common node, such as in a closed network, or cloud-based in which event the modules are located at different nodes. Commonly, the assistant 100 is cloud-based and the rule sets are loaded through an administration interface governed by designated human resources administrators within the enterprise.

In another alternative embodiment, the assistant 100 is configured as a mobile application. Restaurants are a variable in travel that can be more difficult for enterprises to control. Using the features of a smart phone, ipad, tablet computer, and the like, the application can determine a current user location and recommend a restaurant in proximity to the user and/or that meets the rule sets of the enterprise. It may also send the user to restaurants where savings have been negotiated. The same incentive structure can be used to incentivize the user. For example, if the costs of the meal were to be entered, either automatically or manually, the assistant 100 can determine savings and divide the savings as described above.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving, by a microprocessor executable enterprise business expense assistant, one or more parameters defining at least one of an enterprise travel and entertainment expense;
determining, by the microprocessor executable enterprise business expense assistant, a reference point for the at least one of an enterprise travel and entertainment expense;
determining, by the microprocessor executable enterprise business expense assistant, a cost associated with the at least one of an enterprise travel and entertainment expense;
comparing, by the microprocessor executable enterprise business expense assistant, the determined cost and reference point to yield a cost savings associated with the at least one of an enterprise travel and entertainment expense; and
providing an incentive to an enterprise associate, the incentive being related to at least part of the cost savings.

2. The method of claim 1, wherein the enterprise associate is one or more of an employee, consultant, contractor, officer, director, equity owner, and board member, wherein the one or more parameters comprise one or more of date and/or time of departure, date and/or time of arrival, departure location, arrival location, meeting date and/or time, meeting location, type of the at least one of an enterprise travel and expense, reservation date and/or time, and whether the at least one of an enterprise travel and entertainment expense is round-trip or one-way, and wherein the type of the at least one of an enterprise travel and expense is one or more of air travel fare, rental car rental, restaurant dining cost, hotel rate, motel rate, cruise ship fare, ferry charge, cab fare, railway passenger fare, and mass transit fare.

3. The method of claim 1, wherein the cost associated with the at least one of an enterprise travel and entertainment expense is determined based on expense information provided by the Internet website of a service provider associated with the at least one of an enterprise travel and entertainment expense, a navigation and/or mapping application, and a service providing information regarding service provider costs and wherein the expense information is one or more of air passenger carrier, rail passenger carrier, transit, ship, and ferry destinations, schedules, and seat availabilities, travel times between a selected origin and destination, air, rail, transit, ship and ferry fares, rental car availability and rental rates, hotel and/or motel rates and availabilities, restaurant identities, locations, menu and/or food types or selections, and costs, airport, terminal, transit, bus, train, rental car vendor, and hotel/motel, and locations of a point of interest and other locations of interest.

4. The method of claim 3, wherein determining a cost associated with the at least one of an enterprise travel and entertainment expense comprises determining, based on the one or more parameters, a plurality of user options and, for each user option and based on the expense information, an associated cost.

5. The method of claim 4, wherein the reference point is a cost for the at least one of an enterprise travel and entertainment expense and is determined by the one or more parameters and is based on one or more of prior instances of the at least one of an enterprise travel and entertainment expense, expense information for the at least one of an enterprise travel and entertainment expense, a policy and/or rule of the enterprise, prior behavior of the enterprise associate, a hierarchical ranking of the enterprise associate within the enterprise, and a per diem allowance of the enterprise.

6. The method of claim 5, wherein determining a cost associated with the at least one of an enterprise travel and entertainment expense comprises filtering the plurality of user options based on one or more enterprise rule sets to provide a set of filtered options and thereafter providing the filtered options to the enterprise associate for selection of a preferred filtered option, the cost associated with the preferred filtered option being the cost associated with the at least one of an enterprise travel and entertainment expense.

7. A system, comprising:
a microprocessor executable enterprise business expense assistant operable to:
receive one or more parameters defining at least one of an enterprise travel and entertainment expense;
determine a reference point for the at least one of an enterprise travel and entertainment expense;
determine a cost associated with the at least one of an enterprise travel and entertainment expense;
compare the determined cost and reference point to yield a cost savings associated with the at least one of an enterprise travel and entertainment expense; and
provide an incentive to an enterprise associate, the incentive being related to at least part of the cost savings.

8. The system of claim 7, wherein the enterprise associate is one or more of an employee, consultant, contractor, officer, director, equity owner, and board member, wherein the one or more parameters comprise one or more of date and/or time of departure, date and/or time of arrival, departure location, arrival location, meeting date and/or time, meeting location, type of the at least one of an enterprise travel and entertainment expense, reservation date and/or time, and whether the at least one of an enterprise travel and expense is round-trip or one-way, and wherein the type of the at least one of an enterprise travel and expense is one or more of air travel fare, rental car rental, restaurant dining cost, hotel rate, motel rate, cruise ship fare, ferry charge, cab fare, railway passenger fare, and mass transit fare.

9. The system of claim 7, wherein the cost associated with the at least one of an enterprise travel and entertainment expense is determined based on expense information provided by the Internet website of a service provider associated with the at least one of an enterprise travel and entertainment expense, a navigation and/or mapping application, and a service providing information regarding service provider costs and wherein the expense information is one or more of air passenger carrier, rail passenger carrier, transit, ship, and ferry destinations, schedules, and seat availabilities, travel times between a selected origin and destination, air, rail, transit, ship and ferry fares, rental car availability and rental rates, hotel and/or motel rates and availabilities, restaurant identities, locations, menu and/or food types or selections, and costs, airport, terminal, transit, bus, train, rental car vendor, and hotel/motel, and locations of a point of interest and other locations of interest.

10. The system of claim 9, wherein the cost associated with the at least one of an enterprise travel and entertainment expense is determined by determining, based on the one or more parameters, a plurality of user options and, for each user option and based on the expense information, an associated cost.

11. The system of claim 10, wherein the reference point is a cost for the at least one of an enterprise travel and entertainment expense and is determined by the one or more parameters and is based on one or more of prior instances of the at least one of an enterprise travel and entertainment expense, expense information for the at least one of an enterprise travel and entertainment expense, a policy and/or rule of the enterprise, prior behavior of the enterprise associate, a hierarchical ranking of the enterprise associate within the enterprise, and a per diem allowance of the enterprise.

12. The system of claim 11, wherein the cost associated with the at least one of an enterprise travel and entertainment expense is determined by filtering the plurality of user options based on one or more enterprise rule sets to provide a set of filtered options and thereafter providing the filtered options to the enterprise associate for selection of a preferred filtered option, the cost associated with the preferred filtered option being the cost associated with the at least one of an enterprise travel and entertainment expense.

13. A non-transient, tangible computer readable medium comprising microprocessor executable instructions that, when executed, perform the following operations:
receiving one or more parameters defining at least one of an enterprise travel and entertainment expense;
determining a reference point for the at least one of an enterprise travel and entertainment expense;
determining a cost associated with the at least one of an enterprise travel and entertainment expense;
comparing the determined cost and reference point to yield a cost savings associated with the at least one of an enterprise travel and entertainment expense; and
providing an incentive to an enterprise associate, the incentive being related to at least part of the cost savings.

14. The computer readable medium of claim 13, wherein the enterprise associate is one or more of an employee, consultant, contractor, officer, director, equity owner, and board member, wherein the one or more parameters comprise one or more of date and/or time of departure, date and/or time of arrival, departure location, arrival location, meeting date and/or time, meeting location, type of the at least one of an enterprise travel and entertainment expense, reservation date and/or time, and whether the at least one of an enterprise travel and expense is round-trip or one-way, and wherein the type of the at least one of an enterprise travel and expense is one or more of air travel fare, rental car rental, restaurant dining cost, hotel rate, motel rate, cruise ship fare, ferry charge, cab fare, railway passenger fare, and mass transit fare.

15. The computer readable medium of claim 13, wherein the cost associated with the at least one of an enterprise travel and entertainment expense is determined based on expense information provided by the Internet website of a service provider associated with the at least one of an enterprise travel and entertainment expense, a navigation and/or mapping application, and a service providing information regarding service provider costs and wherein the expense information is one or more of air passenger carrier, rail passenger carrier, transit, ship, and ferry destinations, schedules, and seat availabilities, travel times between a selected origin and destination, air, rail, transit, ship and ferry fares, rental car availability and rental rates, hotel and/or motel rates and availabilities, restaurant identities, locations, menu and/or food types or selections, and costs, airport, terminal, transit, bus, train, rental car vendor, and hotel/motel, and locations of a point of interest and other locations of interest.

16. The computer readable medium of claim 15, wherein determining a cost associated with the at least one of an enterprise travel and entertainment expense comprises determining, based on the one or more parameters, a plurality of user options and, for each user option and based on the expense information, an associated cost.

17. The computer readable medium of claim 16, wherein the reference point is a cost for the at least one of an enterprise travel and entertainment expense and is determined by the one or more parameters and is based on one or more of prior instances of the at least one of an enterprise travel and entertainment expense, expense information for the at least one of an enterprise travel and entertainment expense, a policy and/or rule of the enterprise, prior behavior of the enterprise associate, a hierarchical ranking of the enterprise associate within the enterprise, and a per diem allowance of the enterprise.

18. The computer readable medium of claim 17, wherein determining a cost associated with the at least one of an enterprise travel and entertainment expense comprises filtering the plurality of user options based on one or more enterprise rule sets to provide a set of filtered options and thereafter providing the filtered options to the enterprise associate for selection of a preferred filtered option, the cost associated with the preferred filtered option being the cost associated with the at least one of an enterprise travel and entertainment expense.
